(19) United States
(12) Patent Application Publication
(10) Pub. No.: US 2003/0061160 A1
(43) Pub. Date: Mar. 27, 2003

(54) Information processing system for billing system and billing information collection method

(75) Inventor: Hiroshi Asahina, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/243,839

(22) Filed: Sep. 16, 2002

(30) Foreign Application Priority Data
Sep. 21, 2001 (JP) 289179/2001

(51) Int. Cl. G06F 17/60

(52) U.S. Cl. 705/40

(57) ABSTRACT

When a call connection request is transmitted from MS 1 a link is established by PPP processing part 242 and billing control system 245 makes communication timer 244 start counting communication time. If communication conditions over the wireless section deteriorate and/or if there is no transmission/reception of data frames, billing control system 245 makes communication timer 244 halt counting of communication time. Further, if transmission/reception of data resumes, a connection over the wireless section is re-established by BSC 23 and billing control system 245 makes communication timer 244 recover counting of communication time. Finally, if data communication with server 4 is closed, billing control system 245 makes communication timer 244 stop counting communication time.

### BACKGROUND OF THE INVENTION

1. Field of the Invention

The present invention concerns technology for collecting billing information, and more specifically, technology that enables appropriate time counting of communication time of billing information for a terminal even where the connection over a wireless section is released while data communication is taking place.

2. Description of Related Art

One recent format for network connectivity over the Internet involves connecting mobile telephones for example to something like mobile terminals providing connectivity via wireless channels. One method for data communication performed via wireless channels is the digital cellular system CDMA (Code Division Multiple Access). Among the IS-95 A and B (IS-95A/B) standards and the EIA/TIA-707A standards of this CDMA methodology there are standards for procedures for connecting an MS (Mobile Station) to a connectionless network using IP (Internet Protocol) and there is a method of performing data communication via IWF (Inter working Function).

For the configuration of a billing information collection system for billing something like mobile terminals that perform data communication, guidelines are described in the CDMA Mobile IP Implementation Guideline Version 1.5 published by the CDG (CDMA Development Group) and the materials of the TIA/EIA, TR45. 6/99. 05. 17-06 Wireless IP Network Architecture Based on IETF, while WO97/26739 shows a configuration that includes billing nodes and a billing system.

For example, a system for collecting billing information, as shown in FIG. 11, comprises MS (mobile station) 1 and switching system 2 as well as billing system 3 that collects billing information collected at this switching system 2. This switching system 2 comprises BTS (Base Transceiver System) 21, MSC (Mobile Switching Center) 22, BSC (Base Station Controller) 23 and IWF (Inter working Function) 24.

As shown in FIG. 11, the protocol stack of MS 1 and IWF 24 has IS-95A/B, RLP (Radio Link Protocol), PPP (Point to Point Protocol), TCP/IP (Transport Control Protocol/Internet Protocol) and APL (Application).

Operations of the above configuration will now be described.

When BSC 23 receives a call connection request from MS 1, BSC 23 establishes an IS-95 A/B connection at a subordinate layer and allocates channels to be used.

IWF 24 terminates a PPP connection to establish a PPP connection for MS 1.

Once IWF 24 establishes a PPP connection, extraction of billing information commences.

This billing information includes the communication time, total number of packets transmitted, total number of packets received, the total size of packets transmitted cumulatively and the total size of packets received cumulatively.

Next, MS 1, BSC 23 and IWF 24 monitor flow volume of data frames on transmission channels or volume of data frames in their own buffers, while if for a specified time data frames in transmission channels or their own buffers cannot be detected, MS 1, BSC 5 and IWF 6 release the IS-95 A/B connection over the wireless section. Because a PPP connection between MS 1 and IWF 6 is established when there is a call connection request, even if the IS-95 A/B connection is released the PPP connection continues. Further, release of the IS-95 A/B connection on a subordinate layer in the wireless section is also prescribed in IS-707.

If MS 1, BSC 23 and IWF 24 detect data frames on the transmission channels or their own buffer, they re-establish the IS-95 A/B connection.

When data communication with MS 1 is closed, billing information is transferred to billing system 3. Communication time, that is one part of billing information, is the total communication time from the establishment of the PPP connection of IWF 24 until the connection is disconnected or it may be the time used by resources of switching system 2.

Nonetheless, with the configuration described above, a problem exists because a PPP connection remains established even if the IS-95 A/B connection over the wireless section is released and this communication time is counted for the billing information so appropriate billing information cannot be obtained.

Further, a problem arises to remove time in which the IS-95 A/B connection is released, because when an IS-95 A/B connection is released or when an IS-95 A/B connection is re-established, if the information on the IS-95 A/B connection being released or re-established is, in the circumstances, transmitted from the switching system to the billing system, the volume of traffic increases significantly resulting in deteriorating transmission efficiency.

### SUMMARY OF THE INVENTION

Against the background of the above-mentioned problems, the object of the present invention is to provide technology that enables appropriate timing control over communication time in billing information even when the connection over a wireless section has been released.

The above-mentioned problems are solved by an information processing system for a billing system wherein billing information on a terminal connected via wireless channels is collected and this collected billing information is transmitted to and stored in a billing server, which comprises a communication time counting means that starts and/or stops counting of communication time to the terminal in response to a call connection request or call disconnection request transmitted from the terminal, a detection means for detecting data transmitted to the terminal and/or from the terminal, a control means that halts counting of communication time by the communication time counting means if the detection means detects data or recovers counting of communication time by the communication time counting means if the detection means does not detect data, and a transmission means that transmits billing information including communication time counted by the communication time counting means.

The information processing system further comprises a time counting means for counting time during the period in which data is not detected by the detection means and the control means is configured so as to terminate counting of communication time by the communication time counting means if time counted by the time counting means exceeds a specified amount.

The control means may be configured such that a data communication close request instructing that communication of data to the terminal be closed can be transmitted if time counted by the counting means exceeds a specified amount.

The above-mentioned problems are solved through a billing information collection method that is a method for collection of billing information for data communication, that utilizes a billing system that has an information processing system, a terminal and a billing server, which method comprises a step to start counting communication time based on a call connection request transmitted from the terminal to the information processing system, a detection step for detecting data transmission to the terminal and data transmission from the terminal, a step for halting counting the time of data transmission if data transmission to the terminal and/or data transmission from the terminal are not detected, a step to recover the counting of time of data transmission if data transmission to the terminal or data transmission from the terminal is detected, a step for stopping counting data transmission time based on a call disconnection request transmitted from the terminal and a step to transmit billing information including transmission time thus counted to the billing server.

The billing information collection method further comprises a step for counting the time during which the information processing system does not detect data transmission to the terminal or data transmission from the terminal and a step for stopping counting of transmission time and transmitting to the terminal a data communication dose request instructing that communication of data to the terminal be closed, if time counted exceeds a specified amount.

### BRIEF DESCRIPTION OF THE DRAWINGS

Specific embodiments of the present invention will now be described, by way of example only, with reference to the accompanying of drawings in which:

FIG. 1 is a block diagram showing a system for collecting billing information according to a first embodiment of this invention;

FIG. 2 is a block diagram of IWF according to a first embodiment of this invention;

FIG. 3 is a flowchart showing operations according to a first embodiment of this invention;

FIG. 4 shows the transition of internal conditions in the PPP processing part;

FIG. 5 shows the protocol stack;

FIG. 6 shows the protocol stack;

FIG. 7 shows the protocol stack;

FIG. 8 shows communication time of billing information;

FIG. 9 is a block diagram of IWF according to a second embodiment of this invention;

FIG. 10 is a flowchart showing operations according to a second embodiment of this invention; and

FIG. 11 is a block diagram showing an existing system for collecting billing information.

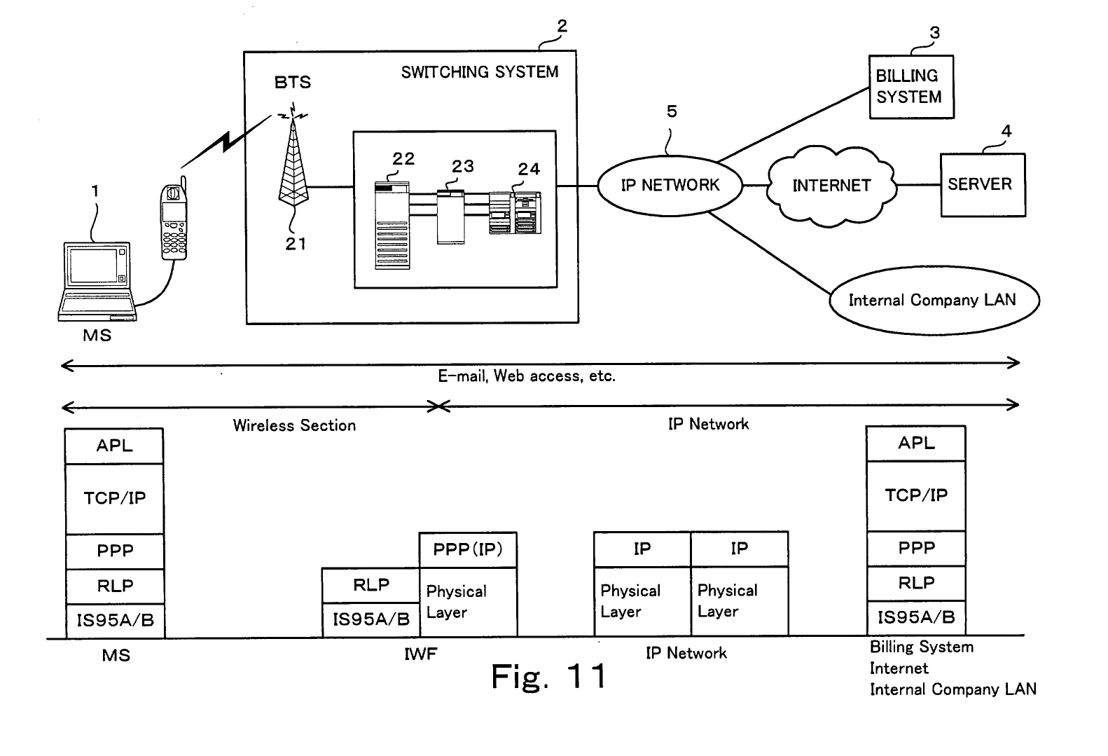

### DETAILED DESCRIPTION OF THE PREFERRED EMBODIMENTS

A first embodiment of this invention will now be described.

In the first embodiment of this invention, if there is a temporary discontinuance of data transmission and/or reception between an MS and information server while data communication between the MS and information server is taking place, the time during which that data transmission and/or reception discontinuance occurs is not included within communication time that comprises one of the items of billing information for the MS.

The first embodiment will now be described in detail.

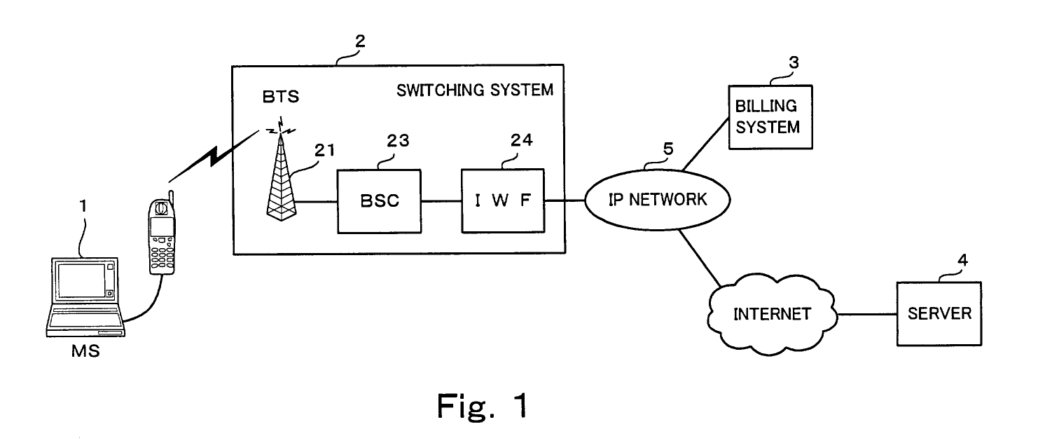

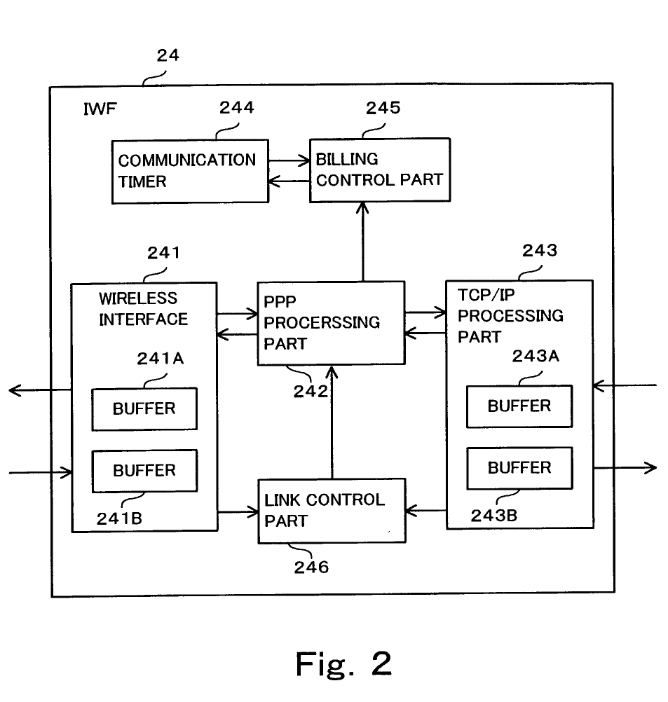

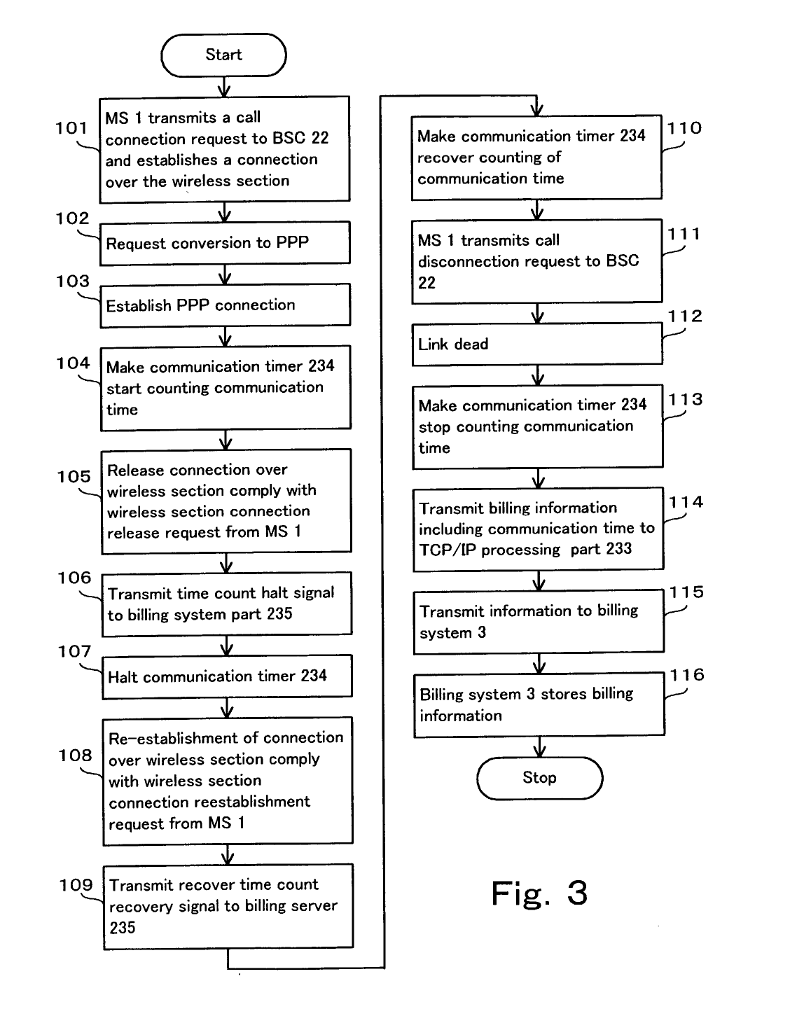

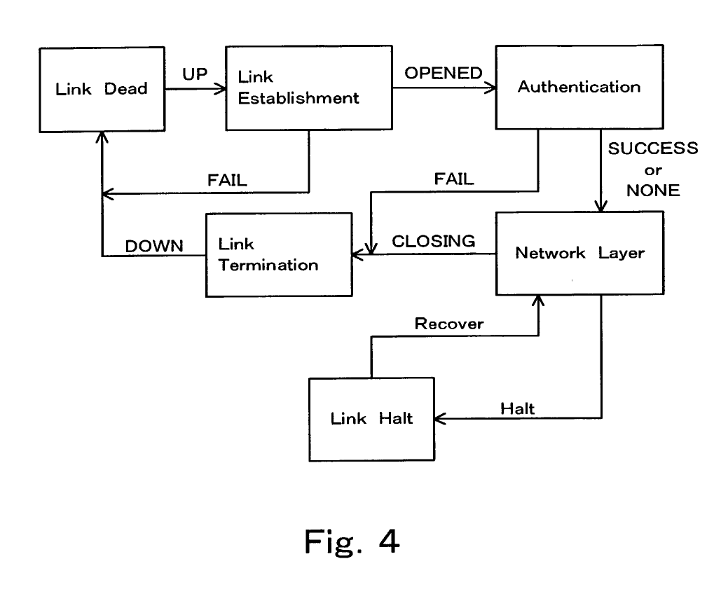

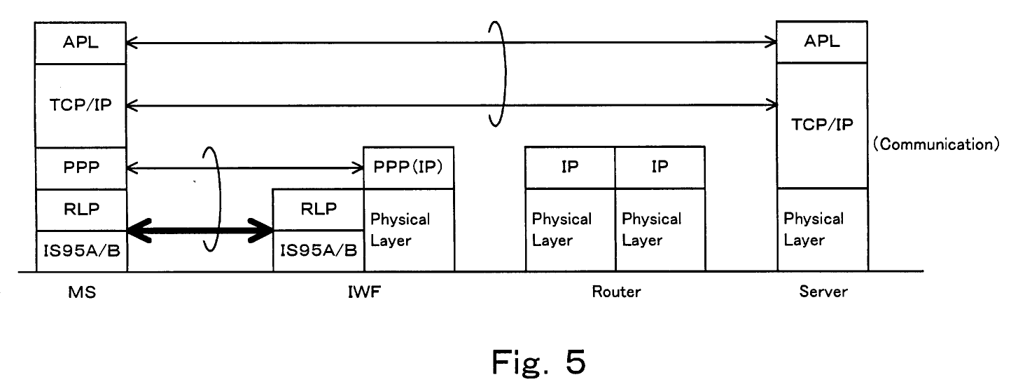

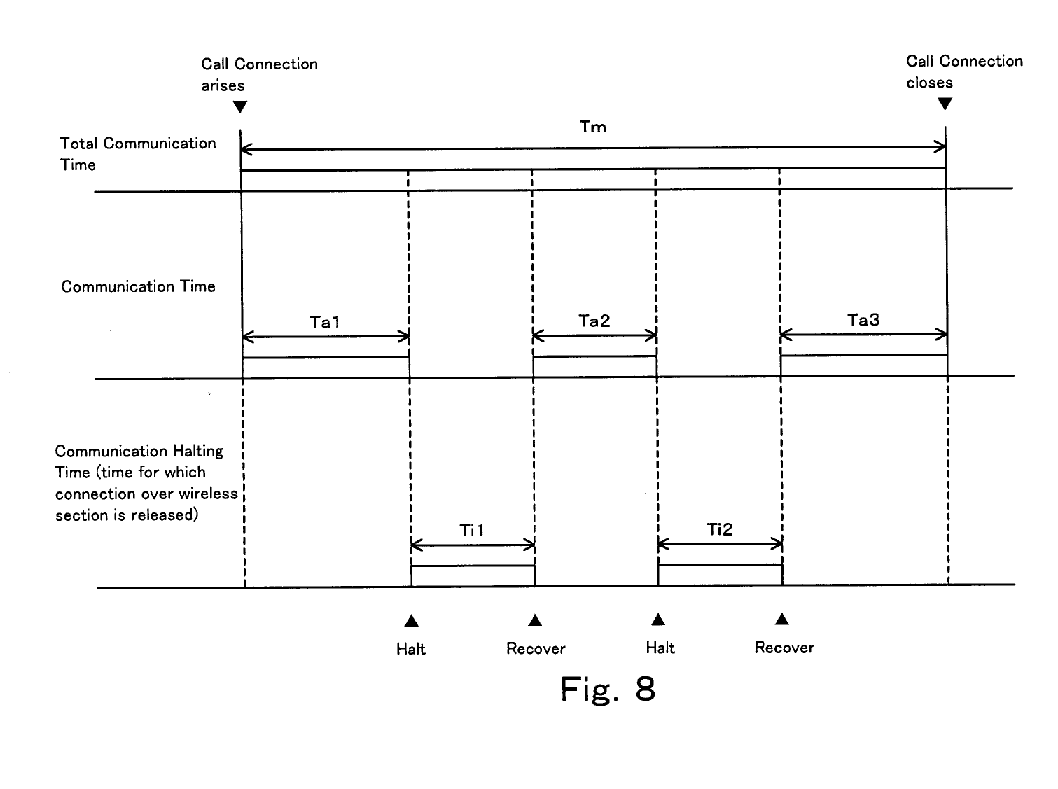

FIG. 1 is a block diagram showing a system for collecting billing information according to the first embodiment of this invention. FIG. 2 is a block diagram of IWF. FIG. 3 is a flowchart showing operations according to a first embodiment of this invention. FIG. 4 shows the transition between conditions in the PPP processing part. FIGS. 5 through 7 show the protocol stack and FIG. 8 shows communication time for billing information.

As shown in FIG. 1, the billing information collection system is comprised of MS (Mobile Station) 1, switching system 2, billing system 3, server 4 and IP network 5 that provides mutual connectivity between switching system 2 and billing system 3.

This switching system 2 comprises BTS (Base Transceiver System) 21, MSC (Mobile Switching Center, not shown in FIG. 1), BSC (Base Station Controller) 23 and IWF (Inter working Function) 24 according to this invention.

MS 1, which may be a personal computer or a mobile telephone for example, performs data communication with remote server 4 via the network. To perform data communication with this remote server 4, MS 1 connects to switching system 2 via wireless channels (wireless section), and transmits data frames of wireless protocol format to switching system 2.

Something like the Internet or an internal company LAN are conceivable as examples of the network at this point.

MS 1 transmits a connection request to switching system 2 for connecting to switching system 2 and a disconnect request for disconnecting from switching system 2.

If communication conditions over the wireless section deteriorate, or if for a specified period of time there is no transmission of data frames of wireless protocol format to switching system 2 moreover, and data frames of wireless protocol format are not received transmitted from switching system 2, MS 1 transmits to switching system 2 a connection release request for the connection over the wireless section. If however communication conditions over the wireless section recover or transmission of data frames of wireless protocol format to switching system 2 occurs, MS 1 transmits a reconnection request for the connection over the wireless section to switching system 2

If BTS 21 receives data frames of wireless protocol format from MS 1, BTS 21 transmits those data frames to BSC 23, and if BTS 21 receives data frames of wireless protocol format from BSC 23, BTS 21 transmits those data frames to MS 1.

If BSC 23 receives a call connection request from MS 1 via BTS 21, BSC 23 establishes a connection over the wireless section and allocates channels to be used for the connection, BSC 23 transmits to IWF 24 data frames of wireless protocol format transmitted from BTS 21 and transmits to BTS 21 data frames of wireless protocol format transmitted from IWF 24.

If BSC 23 receives a call disconnection request from MS 1, in addition to disconnecting the connection over the wireless section, BSC 23 transmits a PPP disconnection request to IWF 23, while if BSC 23 receives a disconnection request for the connection over the wireless section from IWF 24, BSC 23 transmits a call disconnection request to MS 1 via BTS 21, disconnects the connection over the wireless section and closes data communication with MS 1.

BSC 23 monitors communication conditions over the wireless section and if it detects a deterioration in those conditions, BSC 23 transmits a connection release request for the connection over the wireless section to MS 1 via BTS 21. If however, BSC 23 detects a recovery in communication conditions over the wireless section, BSC 23 transmits to MS 1 via BTS 21 a connection re-establishment request for the connection over the wireless section for re-establishing the connection over the wireless section. IWF 24 also detects the release or re-establishment of such connections over the wireless section and implements control over counting of communication time.

IWF 24 converts data frames of wireless protocol format into IP packet format and also acts as a protocol conversion means performing conversions in the opposite direction, making a decision whether or not data frames of wireless protocol format are being transmitted from BSC 23, so that if, temporarily, such data frames are not being transmitted from BSC 23, IWF 24 transmits a connection release request for the connection over the wireless section to BSC 23, facilitating the release of the connection over the wireless section. The occurrence of data frames of wireless protocol format moving from MS 1 to the IP network at this point is equivalent to a request for a reconnection over the wireless section issued from MS 1, and is therefore detected by IWF 24. On the other hand, when IWF 24 detects the occurrence of data that should be transmitted to MS 1, that is to say, IWF 24 detects data moving from the IP network to MS 1, IWF 24 transmits to BSC 23 a connection re-establishment request for the connection over the wireless section, for re-establishing the connection over the wireless section.

As shown in FIG. 2, IWF 24 comprises wireless interface part 241, PPP processing part 242, TCP/IP processing part 243, communication timer 244, billing control part 245 and link control part 246.

Wireless interface part 241 stores wireless protocol format data frames from BSC 23 in buffer 241A and once a specified volume of such data frames is reached, those data frames are transmitted to PPP processing part 242 and link control part 246.

Wireless interface part 241 stores wireless protocol format data frames from PPP processing part 242 in buffer 241B and once a specified volume of such data frames is reached, those data frames are transmitted to BSC 23. Although not shown in the drawings, wireless interface part 241 transmits connection release request and reconnection request signals for a connection over a wireless section, which signals are controlled by link control part 246, to BSC 23.

PPP processing part 242 deciphers wireless protocol data frames from wireless interface part 241, converting the IP packets and transmits these IP packets to TCP/IP processing part 243.

Further, if PPP processing part 242 receives IP packets from TCP/IP processing part 243, part 242 converts these IP packets into wireless protocol format data frames and transmits them to wireless interface part 241. The method for converting from wireless protocol format data frames to IP packets, the method for converting from IP packets to wireless protocol format data frames and the procedures for PPP protocol connection are known, existing technology. Accordingly, no detailed explanation of these procedures and methods is offered here.

Moreover, PPP processing part 242 establishes a PPP protocol connection based on data input from wireless interface part 241 and once the connection is established, part 242 transmits to billing control part 245 a time count start signal instructing that counting of communication time commences. Once part 242 receives a PPP connection disconnection request from link control part 246 (described subsequently), part 242 makes the link dead and in addition to disconnecting the connection of PPP protocol, transmits to billing control part 245 a time count stop signal instructing that counting of communication time stops.

Moreover, if PPP processing part 242 receives a link halt signal from link control part 246, in addition to halting the PPP protocol link, part 242 transmits to billing control part 245 a time count halt signal to halt time counting of communication time. Once part 242 receives a recover link signal from part 246, in addition to recovering the PPP protocol link, part 242 transmits to part 245 a time count recovery signal to recover counting of communication time.

TCP/IP processing part 243 stores IP packets from PPP processing part 242 in buffer 243A and once a specified volume of such IP packets is reached, part 243 transmits those packets to IP network 5. Part 243 stores IP packets from IP network 5 in buffer 243B and once a specified volume of such IP packets is reached, part 243 transmits those packets to part 242 and link control part 246.

TCP/IP processing part 243 transmits billing information from billing control part 245 to billing system 3.

Communication timer 244 measures communication time with MS 1 in accordance with instructions from billing control part 245.

In addition to stopping counting of communication time by communication timer 244, billing control part 245 is a part that measures the total number of packets transmitted, total number of packets received, the total size of packets transmitted cumulatively and the total size of packets received cumulatively.

When billing control part 245 receives a time count start signal from PPP processing part 242, part 245 makes communication timer 244 start counting time. When part 245 receives a time count halt signal from part 242, part 245 makes timer 244 temporarily halt time counting and when part 245 receives a time count recovery signal from part 242, part 245 makes timer 244 recover time counting.

When billing control part 245 receives a time count stop signal from PPP processing part 242, in addition to making communication timer 244 stop counting communication time, part 245 reads-out communication time counted by timer 244 and transmits billing information including the communication time thus read-out to TCP/IP processing part 243.

Link control part 246 monitors wireless protocol format data frames stored in buffer 241A of wireless interface part 241 and IP packets stored in buffer 243B of TCP/IP processing part 243. If such wireless protocol format data frames stored in buffer 241A of part 241 and/or such IP packets stored in buffer 243B of part 243 are no longer present, part 246 transmits a link halt signal to PPP processing part 242.

When wireless protocol format data frames are re-stored in buffer 241A of wireless interface part 241 or when IP packets are re-stored in buffer 243B of TCP/IP processing part 243, link control part 246 transmits a recover link signal to PPP processing part 242.

Billing system 3 is the same as existing billing systems and stores billing information received transmitted from switching system 2.

Server 4 performs data transmission with MS 1.

Operations occurring in the above configuration will now be described.

The following operations as described are operations for the performance of call disconnect, lead by MS 1. The information processing system for a billing system of this invention and the billing information processing methods as they pertain to performance of a disconnect from the switching system 2 side (not shown in the drawings), are not the subject of inquiry here and are therefore omitted from the description.

To perform data transmission with server 4 MS 1 transmits to BSC 23 via BTS 21 a call connection request for a connection over a wireless section. Upon receiving this call connection request, BSC 23 establishes a connection over the wireless section (Step 101).

Once a connection is established over the wireless section, MS 1 transmits wireless protocol format data frames. Upon receiving such data frames, BSC 23 transmits these data frames to IWF 24 and requests conversion to PPP (Step 102).

Wireless interface part 241 of IWF 24 stores wireless protocol format data frames from BSC 23 in buffer 241A and transmits the data frames thus stored in buffer 241A to PPP processing part 242. Upon receiving these data frames part 242 deciphers them, establishes a PPP connection (Step 103), and as shown in FIG. 4, establishes a link.

PPP processing part 242 performs authentication based on data included in wireless protocol format data frames and makes its condition transition to the network layer condition.

Further, once PPP processing part 242 has completed establishing the link, in addition to converting wireless protocol format data frames into IP packets, part 242 transmits to billing control part 245 a time count start signal instructing that counting of communication time commences. Upon receiving this time count start signal, part 245, in addition to making communication timer 244 start counting communication time, commences counting the number of packets transmitted or received and the number of bytes transmitted or received (Step 104).

TCP/IP processing part 243 stores IP packets from PPP processing part 242 in buffer 243A and transmits such IP packets stored in buffer 243A to IP network 5.

In this way, transmission and reception of IP packets performed between MS 1 and IP network 5 occurs via wireless interface part 241 of IWF 24, PPP protocol control part 242 and TCP/IP processing part 243. Further, as shown in FIG. 5, when data communication is performed between MS 1 and server 4, the condition of the protocol stack is that connections of all layers (IS95A/B, RLP, PPP, TCP/IP. APL) are maintained.

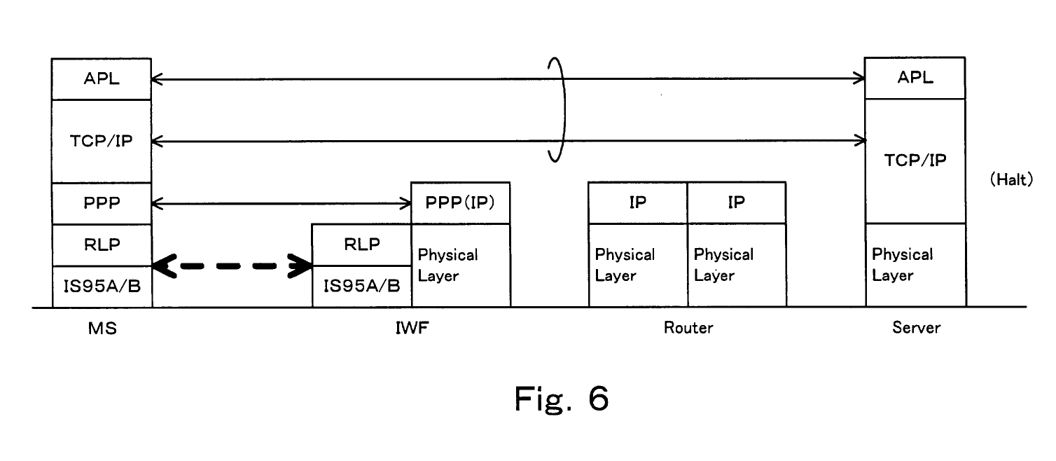

If communication conditions over the wireless section deteriorate and/or if there is no transmission/reception of data frames, MS 1 transmits a connection release request for the connection over the wireless section. Upon receiving this release request BSC 23 releases the connection over the wireless section (Step 105). As shown in FIG. 6, the condition of the protocol stack in this situation is that the connection over the wireless section (IS95A/B, RLP) is released and a connection on a higher layer than the wireless section (PPP, TCP/IP. APL) is in an established state.

Link control part 246 detects that wireless protocol format data frames transmitted from wireless interface part 241 have not been received and transmits a link halt signal to PPP processing part 242. As shown in FIG. 4, upon receiving this link halt signal, part 242 makes its internal condition transition from the network layer condition to the link halt condition and transmits a time count halt signal to billing control part 245 (Step 106). At this time, part 246 monitors IP packets stored in buffer 243B of TCP/IP processing part 243 and confirms that there are no IP packets present. If, at this point, IP packets were present, part 246 would, in addition to transmitting a recover link signal to part 242, initiate a reconnection over the wireless section by BSC 23.

If billing control part 245 receives a time count halt signal from PPP processing part 242, part 245 makes communication timer 244 halt time counting (Step 107) so that, while counting itself of the number of transmitted/received packets and the number of transmitted/received bytes by part 245 is not stopped, data communication is halted so those packets and bytes are not counted.

Thereafter, if data for transmission arises, MS 1 transmits a reconnection request for the connection over the wireless section to BSC 23. Upon receiving this reconnection request, BSC 23 establishes a connection over the wireless section (Step 108).

Once a connection over the wireless section is established, MS 1 transmits wireless protocol format data frames. Upon receiving such data frames, BSC 23 transmits wireless protocol format data frames to IWF 24.

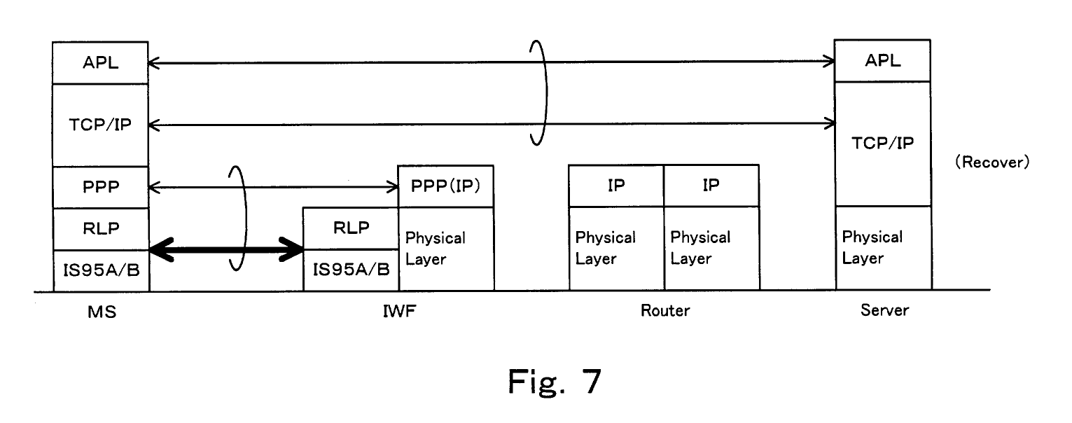

Link control part 246 detects wireless protocol format data frames stored in buffer 241A of wireless interface part 241, so part 246 transmits a recover link signal to PPP processing part 242. Upon receiving this recover link signal, part 242 makes its internal condition transition from the link halt condition to the network layer condition as shown in FIG. 4. The condition of the protocol stack at this time, is, in the same manner as when data communication is performed between MS 1 and server 4, that connections of all layers (IS95A/B, RLP, PPP, TCP/IP. APL) are in an established state, as shown in FIG. 7.

Moreover, PPP processing part 242 makes its internal condition transition to the network layer condition and transmits a time count recovery signal to billing control part 245 (Step 109). Upon receiving this signal, part 245 makes communication timer 244 recover time counting of communication time (Step 110).

Next, when MS 1 is going to closes data communication with server 4, MS 1 transmits to BSC 23 via BTS 21, a call disconnection request requesting release of the connection over the wireless section and closure of data transmission (Step 111).

Upon receiving a call disconnection request from MS 1, BSC 23 releases the connection over the wireless section and transmits a PPP connection disconnection request to IWF 24. Upon receiving this PPP connection disconnection request, PPP processing part 242 of IWF 24 makes its internal condition transition from the network layer condition to the link disconnected condition, as shown in FIG. 4, and further makes its internal condition transition from the link disconnected condition to the link dead condition (Step 112).

PPP processing part 242 transmits a time count stop signal to billing control part 245. Upon receiving this signal, part 245 makes communication timer 244 stop counting communication time. As shown in FIG. 8, for example, total communication time from reception of a call connection request until reception of a call disconnection request (from generation of the call connection until disconnection of the call connection) is Tm time. If data communication is interrupted because communication conditions over the wireless section deteriorate or there is no transmission/reception of data frames, the length of interruption of communication time for the period of interruption of data communication would be Ti1 time and Ti2 time, so communication time as counted by timer 244 would be Tm-Ti1-Ti2 (Step 113).

Billing control part 245 reads-out communication time counted by communication timer 244 and transmits billing information including the communication time thus read-out to TCP/IP processing part 243 (Step 114). Upon receiving this billing information part 243 transmits to billing system 3 this billing information and information indicating closure of data communication showing that data communication with MS 1 has closed (Step 115).

Upon receiving information indicating closure of data communication and billing information from TCP/IP processing part 243, billing system 3 stores this billing information (Step 116).

A second embodiment of this invention will now be described.

In the second embodiment of this invention the length of time that a connection over a wireless section is released is counted and if that time exceeds a specified amount of time, in addition to data communication being closed, time counting of communication time is stopped.

The second embodiment will now be described in detail.

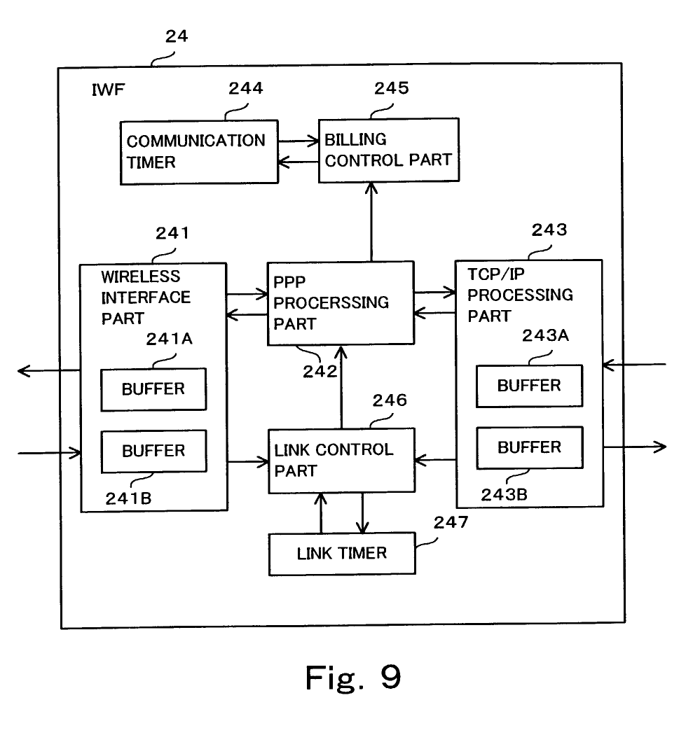

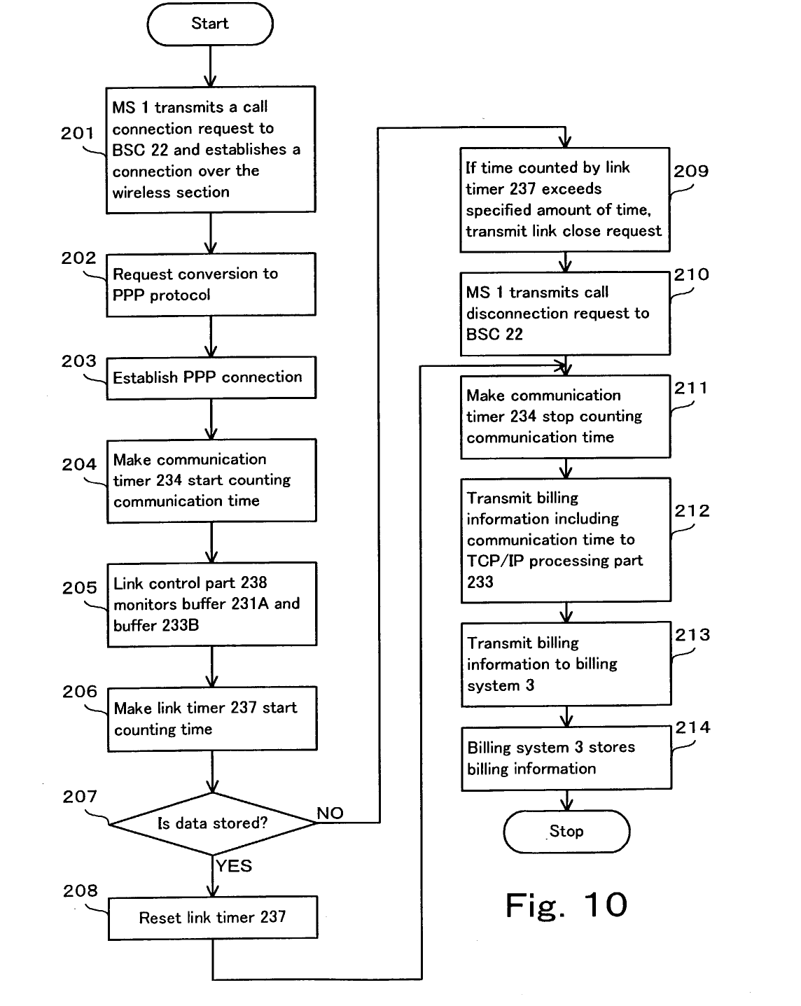

FIG. 9 is a block diagram of IWF. FIG. 10 is a flowchart showing operations according to a second embodiment of the present invention.

Things which are of the same configuration as for the first embodiment are marked with the same numbers and a detailed explanation of them is omitted.

In accordance with instructions from link control part 248, link timer 247 performs time measurement of the time in which the internal conditions of PPP processing part 242 are in the link halt condition.

Link control part 248 monitors buffer 241A of wireless interface part 241 and buffer 243B of TCP/IP processing part 243 and when wireless protocol format data frames are not stored in buffer 241A moreover IP packets are not stored in buffer 243B, in addition to transmitting a link halt signal to PPP processing part 242, part 248 makes link timer 247 start time counting.

Further, if wireless protocol format data frames are not stored in buffer 241A and/or IP packets are not stored in buffer 243B, in addition to transmitting a recover link signal to PPP processing part 242, link control part 248 makes link timer 247 stop time counting and resets link timer 247.

Moreover, if time counted by link timer 247 exceeds a specified amount link control part 248 transmits a PPP connection disconnection request to PPP processing part 242.

Operations of the above configuration will now be described.

To perform data transmission with server 4, MS 1 transmits to BSC 23 via BTS 21 a call connection request for a connection over a wireless section. Upon receiving this call connection request, BSC 23 establishes a connection over the wireless section (Step 201) and, in addition to transmitting wireless protocol format data frames from MS 1 to IWF 24, BSC 23 transmits to IWF 24 a conversion request requesting conversion of these data frames thus transmitted to PPP (Step 202).

PPP processing part 242 of IWF 24 deciphers the wireless protocol format data frames from BSC 23, establishes a PPP connection and establishes a link (Step 203).

Further, in addition to converting wireless protocol format data frames into IP packets, PPP processing part 242 of IWF 24 transmits to billing control part 245 a time count start signal instructing that counting of communication time commences. Upon receiving this time count start signal, part 245, in addition to making communication timer 244 start counting communication, starts counting the number of packets transmitted or received and the number of bytes transmitted or received (Step 204).

TCP/IP processing part 243 transmits IP packets from PPP processing part 242 to network 5.

Next, link control part 248 monitors buffer 241A of wireless interface part 241 and buffer 243B of TCP/IP processing part 243 (Step 205).

When wireless protocol format data frames are not stored in buffer 241A moreover IP packets are not stored in buffer 243B, link control part 248, in addition to transmitting a link halt signal to PPP processing part 242, makes link timer 247 start time counting (Step 206).

Further, part 248 monitors buffer 241A to ascertain whether or not wireless protocol format data frames are stored there and monitors buffer 243B to ascertain whether or not IP packets are stored there (Step 207).

If wireless protocol format data frames are not stored in buffer 241A and/or IP packets are not stored in buffer 243B, in addition to transmitting a recover link signal to PPP processing part 242, link control part 248 makes link timer 247 stop time counting and resets link timer 247 (Step 208).

If time counted by link timer 247 exceeds a specified amount link control part 248 transmits a PPP connection disconnection request to PPP processing part 242 (Step 209). Upon receiving this link disconnection request, part 242 makes its internal condition transition from the network layer condition to the link closed condition and further makes its internal condition transition from the link closed condition to the link dead condition.

Link control part 248 then transmits to BSC 23 via wireless interface part 241 a close request for the connection over the wireless section instructing that data communication with MS 1 be closed. Upon receiving this connection disconnection request, BSC 23 transmits a call disconnection request to MS 1 and makes data communication with MS 1 stop (Step 210).

PPP processing part 242 transmits a time count stop signal to billing control part 245. Upon receiving this signal, part 245 makes communication timer 244 stop counting communication time (Step 211), reads-out communication time counted by timer 244 and transmits billing information including the communication time thus read-out to TCP/IP processing part 243 (Step 212).

If TCP/IP processing part 243 receives billing information from billing control part 245, part 243 transmits to billing system 3 this billing information and information indicating closure of data communication showing that data communication with MS 1 has closed (Step 213). Billing system 3 receives this information indicating closure of data communication and billing information and stores it (Step 214).

A significant effect achieved according to this invention is that even when, due to a deterioration in communication conditions for example over a wireless section, the connection over the wireless section is released, because communication time during the time period in which the connection over the wireless section was released is not included in billing information, appropriate billing information can be collected.

A further significant effect achieved according to this invention is that there is no increase in the volume of traffic of a billing system because when the connection over a wireless section is released or reconnected, there is no need for any notification signal from a switching system to the billing system.

Another significant effect achieved according to this invention is that there is no need for a change of billing system and an existing billing system can therefore be used.

What is claimed is:

1. An information processing system for a billing system wherein billing information on a terminal connected via wireless channels is collected and said collected billing information is transmitted to and stored in a billing server, which comprises:
a communication time counting means that starts and/or stops counting of communication time to said terminal in response to a call connection request or call disconnection request transmitted from said terminal;
a detection means for detecting data transmitted to said terminal and/or from said terminal;
a control means that halts counting of communication time by said communication time counting means if said detection means detects data or recovers counting of communication time by said communication time counting means if said detection means does not detect data; and
a transmission means that transmits billing information including communication time counted by said communication time counting means.

2. The information processing system according to claim 1 which further comprises a time counting means for counting time during the period in which data is not detected by said detection means and said control means is configured so as to terminate counting of communication time by said communication time counting means if time counted by said time counting means exceeds a specified amount.

3. The information processing system according to either claim 1 or claim 2 wherein said control means is configured such that a data communication close request instructing that communication of data to said terminal be closed can be transmitted if time counted by said counting means exceeds a specified amount.

4. A billing information collection method that is a method for collection of billing information for data communication, that utilizes a billing system that has information processing equipment, a terminal and a billing server, which comprises:
a step to start counting communication time based on a call connection request transmitted from said terminal to said information processing equipment;
a detection step for detecting data transmission to said terminal and data transmission from said terminal;
a step for halting counting the time of data transmission if data transmission to said terminal and/or data transmission from said terminal are not detected;
a step to recover counting the time of data transmission if data transmission to said terminal or data transmission from said terminal is detected; and
a step for stopping counting data transmission time based on a call disconnection request transmitted from said terminal and a step to transmit billing information including transmission time thus counted to said billing server.

5. The billing information collection method according to claim 4 that comprises a step for counting the time during which said information processing equipment does not detect data transmission to said terminal or data transmission from said terminal and a step for stopping counting of transmission time and transmitting to said terminal a data communication close request instructing that communication of data to said terminal be closed, if time counted exceeds a specified amount.
